(19) United States
(12) Patent Application Publication
(10) Pub. No.: US 2010/0018416 A1
(43) Pub. Date: Jan. 28, 2010

(54) APPARATUS AND METHOD FOR DRIVING A PRINTING PRESS

(75) Inventor: Shinichiro Senoo, Hiroshima (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/374,858

(22) PCT Filed: Sep. 21, 2007
(86) PCT No.: PCT/JP2007/068435

§ 371 Date: Jan. 23, 2009

(30) Foreign Application Priority Data
Sep. 22, 2006 (JP) 2006-257622

(51) Int. Cl. B41L 23/00

(52) U.S. Cl. 101/147

(57) ABSTRACT

A printing-press driving apparatus and method capable of printing that employs a processless plate in order to suppress an increase in waste paper by properly performing a water process on the processless plate. In a water process in the case of employing the processless plate, control is performed so that while a plate cylinder with the processless plate placed thereon is being rotated without actual contact with continuous paper, the water process is performed only for a predetermined period of time, and continuous paper travels at a lower speed than a peripheral speed of the plate cylinder.

### TECHNICAL FIELD

The present invention relates to an apparatus and method for driving a printing press capable of printing with a processless plate.

### BACKGROUND ART

In lithographic presses, such as sheet-fed offset printing presses, commercial web offset presses, and newspaper web offset, CTP (computer to plate) that outputs a printing plate (PS plate; pre-sensitized plate) directly from data is coming into use. In CTP, CTP plates have hitherto been subjected to drawing using a laser, development, and gumming processes.

At present, in the CTP, with the advent of processless plates (processless CTP plate), printing plates in which a development process is unnecessary in the platemaking process are being used. As development of the processless plates is not performed in the platemaking process, they have various advantages, such as space saving of developers in a platemaking process (such as storage, control, and disposal of chemicals), less environmental damage than conventional printing plates, and so forth.

In a method of making the processless plate, a planographic plate material is first exposed. Then, with the exposed planographic plate material placed on a plate cylinder of a printing press, by applying ink for printing alone or ink for printing and dampening solution to the plate surface, unnecessary parts for printing are removed from the exposed surface, whereby development is performed. By way of example, patent document 1 discloses a technique for performing development by applying dampening solution for printing to the plate surface of a printing plate (water process). In addition, as a technique for shortening the developing time on the plate cylinder of the processless plate, patent document 2 discloses a technique in which the supply of dampening solution and ink in a water process is carried out at optimum timing.

Patent Document 1: Japanese patent No. 2938397

Patent Document 2: Japanese patent laid-open publication No. 2000-52634

### DISCLOSURE OF THE INVENTION

### Problems to be Solved by the Invention

In the water process, the printing press is caused to idle. Because of this, a paper (a web as a continuous paper) put on the printing press is discharged by operation of the printing press and results in waste paper (broken). In the case of the printing press, makeready time, for example, for a rise in the temperature of a dryer is necessary as makeready for printing, and during the makeready time, waste paper also occurs. Since the processing time in the water process is added to the printing makeready time, an increase in the makeready time of the printing press itself due to this and an increase in waste paper due to water processing have become serious problems.

Note that continuous paper is considered to be cut off once to prevent waste paper. However, in this case, it is necessary to join the separated parts again and discharge the joined part at low speed to prevent paper jamming at a folder etc. Although waste paper can be reduced, the makeready time will be significantly increased and thus productivity will be reduced.

The present invention has been made in view of the circumstances described above. Accordingly, it is an object of the present invention to provide an apparatus and method for driving a printing press, which are capable of properly performing a water process on a processless plate to suppress an increase in waste paper due to the water process.

### Means for Solving the Problems

To achieve the above object, an apparatus for driving a printing press of the present invention is provided an apparatus for driving a printing press capable of printing on continuous paper using a processless plate on which development is performed by a water process in which dampening solution is supplied to a plate surface on a plate cylinder. The apparatus includes control means which, in the water process in the case of employing the processless plate, performs control so that while the plate cylinder with the processless plate placed thereon is being rotated without actual contact with the continuous paper, the water process is performed only for a predetermined period of time, and the continuous paper travels at a lower speed than a peripheral speed of the plate cylinder.

The peripheral speed of the plate cylinder in the water process is preferably set at a speed such that transfer of water to a plate surface of the processless plate is a predetermined level or greater.

In this case, the travel speed of the continuous paper in the water process is preferably set at an operable minimum speed in a speed range in which an adhesion quantity of water to the continuous paper by the water process is within a strength of a water resistance of the continuous paper.

The travel speed of the continuous paper in the water process is preferably set variable according to the strength of the water resistance of the continuous paper.

In this case, the control means preferably performs control so that a rise in temperature of a dryer of the printing press is performed in parallel with the water process, and the water process is completed at the time or before the rise in the dryer temperature is completed.

A method of driving a printing press of the present invention is a method of driving a printing press capable of printing on continuous paper using a processless plate on which development is performed by a water process in which dampening solution is supplied to a plate surface on a plate cylinder. The printing-press driving method includes a control step which, in the water process in the case of employing the processless plate, performs control so that while the plate cylinder with the processless plate placed thereon is being rotated without actual contact with the continuous paper, the water process is performed only for a predetermined period of time, and the continuous paper travels at a lower speed than a peripheral speed of the plate cylinder.

The peripheral speed of the plate cylinder in the water process is preferably set at a speed such that transfer of water to a plate surface of the processless plate is a predetermined level or greater.

The travel speed of the continuous paper in the water process is preferably set at an operable minimum speed in a speed range in which an adhesion quantity of water to the continuous paper by the water process is within a strength of a water resistance of the continuous paper.

The travel speed of the continuous paper in the water process is preferably set variable according to the strength of the water resistance of the continuous paper.

The control step preferably performs control so that a rise in temperature of a dryer of the printing press is performed in parallel with the water process, and the water process is completed at the time or before the rise in the dryer temperature is completed.

It is also preferable that the temperature of dampening solution to be supplied to the printing plate in the water process be adjusted to a predetermined proper temperature. Since the temperature of dampening solution to be supplied to the printing plate in the water process is adjusted to the predetermined proper temperature, this makes it possible to quickly perform the water process.

For instance, if the temperature of water in the water process is higher than the normal temperature, development efficiency is so good that the water process can be quickly completed.

For at least one of the API function, ink speed following function, and water fountain roller speed following function relating to control of the printing units, a dedicated function for the processless plate is provided in advance separately from those of a normal printing plate on which development has been performed in a platemaking process, and preferably, if the printing plate is determined to be the processless plate by the printing decision, the printing units are controlled employing the dedicated function for the processless plate. Therefore, in the case of the printing plate being the processless plate, the printing units are controlled employing the dedicated functions for the processless plate (API function, ink speed following function, and water fountain roller speed following function), so printing by the processless plate can be properly performed.

In addition, if each of the printing units is controlled so that other processes of the printing makeready are started (after the printing press is shut down once, or in series) after the water process is finished, the same processes as the printing makeready in the case of printing that employs normal printing plates not requiring the water process may be carried out after the water process, and therefore each process can be easily and properly performed.

Furthermore, if each of the control units is controlled so that other processes of the printing make ready are carried out in parallel with the water process, the time required for the printing makeready can be shortened.

The other processes of the printing makereadys preferably include any of dryer temperature raising, preliminary ink supply, impression cylinder or blanket washing processes.

### ADVANTAGES OF THE INVENTION

According to the printing-press driving apparatus and method of the present invention, in the water process in the case of using the processless plate at the time of plate exchange, while the plate cylinder with the processless plate placed thereon is being rotated without actual contact with continuous paper, the water process is performed only for a predetermined period of time, and the continuous paper travels at a lower speed than a peripheral speed of the plate cylinder. Therefore, for example, with the plate cylinder being operated at high speed to some degree, the continuous paper can travel at a speed much lower than the plate cylinder. If the plate cylinder is rotated at high speed to some degree, a stable development process can be performed on the whole surface of the plate cylinder and thus the development of the entire plate cylinder can be quickly performed. On the other hand, if the speed of the continuous paper is decreased, waste paper in the water process can be reduced.

If the peripheral speed of the plate cylinder in the water process is set at a speed such that transfer of water to the plate surface of the processless plate is a predetermined level or greater, water process (development) can be carried out with better efficiency.

In addition, if the travel speed of the continuous paper in the water process is set at an operable minimum speed in a speed range in which an adhesion quantity of water to the continuous paper by the water process is within the strength of the water resistance of the continuous paper, the occurrence of waste paper can be effectively suppressed while avoiding cutting-off of the continuous paper that may occur when the continuous paper is stopped or travels at very low speed.

If the travel speed of the continuous paper in the water process is set variable according to the strength of the water resistance of the continuous paper, the occurrence of waste paper can be more effectively suppressed while avoiding cutting-off of the continuous paper that may occur.

In addition, if control is performed so that a rise in temperature of a dryer of the printing press is performed in parallel with the water process, and the water process is completed at the time or before the rise in the dryer temperature is completed, printing can be started at the same time when the dryer temperature rise is completed. Therefore, during water process and dryer temperature rise, the continuous paper is caused to travel at low speed in order to suppress the occurrence of waste paper, and after dryer temperature rise, printing can be performed by quickly accelerating the continuous paper to printing speed, so that cutting-off of paper can be avoided which occurs by excessive drying of the continuous paper by the dryer after the dryer temperature rise. That is, if water process is not completed even if rising dryer temperature is completed, the continuous paper is caused to travel through the high-temperature dryer at low speed from the viewpoint of suppressing the occurrence of waste paper while waiting for completion of water process after dryer temperature rise. As a result, if the continuous paper passes through the high-temperature dryer at low speed, the paper will be excessively dried with the dryer and thus the possibility of paper being cut off will occur. However, since the continuous paper can be quickly accelerated to printing speed after dryer temperature rise, such a possibility can be avoided.

### BRIEF DESCRIPTION OF THE DRAWINGS

FIG. 1 is a configuration diagram showing a printing press and a driving apparatus for the printing press in accordance with one embodiment of the present invention;

FIG. 2 is a flowchart used to explain how plate exchange is performed according to plate classification by the printing-press driving apparatus and method in accordance with one embodiment of the present invention;

FIG. 3 is a flowchart used to explain how a water process is performed by the printing-press driving apparatus and method in accordance with one embodiment of the present invention;

FIGS. 4A and 4B are flowcharts used to explain examples of a process that is performed during plate exchange by the printing-press driving apparatus and method in accordance with one embodiment of the present invention, FIG. 4A showing a first example and FIG. 4B a second example;

FIGS. 5A and 5B are flowcharts used to explain examples of a printing make ready process that is performed during plate exchange by the printing-press driving apparatus and method in accordance with one embodiment of the present invention, FIG. 5A showing a first example and FIG. 5B a second example;

FIGS. 6A to 6C are graphs used to explain an advantage of speed control that is obtained by the printing-press driving apparatus and method in accordance with one embodiment of the present invention, FIG. 6A showing the present embodiment and FIGS. 6B and 6C comparative examples; and

FIG. 7 is a time chart used to explain an example of a printing makeready process that is performed by the printing-press driving apparatus and method in accordance with one embodiment of the present invention.

### DESCRIPTION OF REFERENCE NUMERALS

1 Paper feed section
2 Infeed section
2a, 31a to 34a, 5a, 6a, 7a Drive motor (shaftless motor)
3 Printing section
4 Dryer section (dryer)
5 Cooling section
6 Web pass section
7 Folding machine
8 Motor controller
9 Controller as control mean (general controller)
10 Web as printing paper (Continuous paper)
10a Roll
11 Reel stand
12 Brake
31 to 34 Printing unit
31b to 34b Plate cylinder
31c to 34c Blanket cylinder

### BEST MODE FOR CARRYING OUT THE INVENTION

Embodiments of the present invention will hereinafter be described with reference to the drawings.

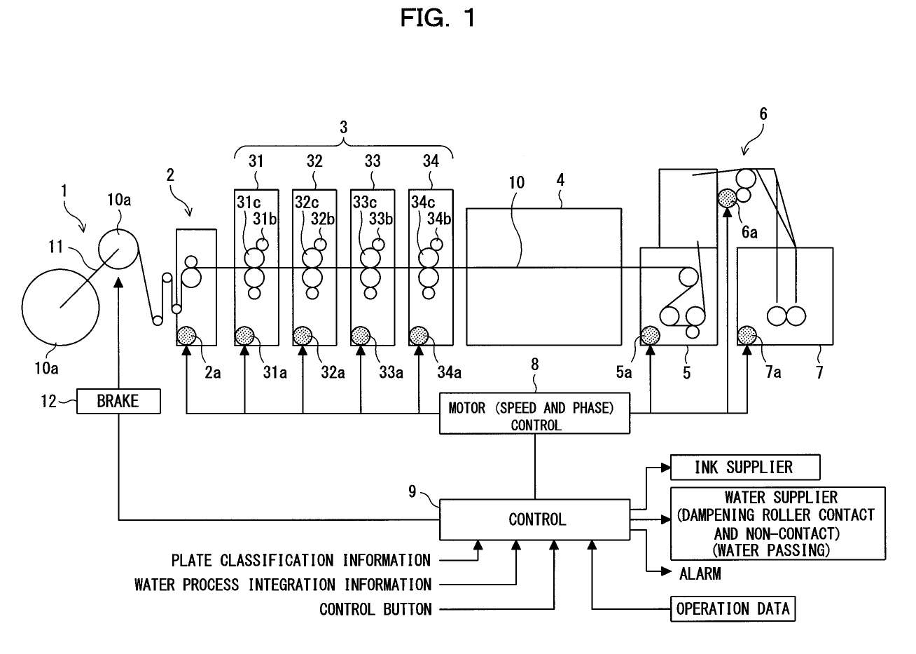

FIGS. 1 to 5 are used for explaining a printing press and an apparatus and method for driving the printing press, in accordance with one embodiment of the present invention.

The printing press according to this embodiment, as shown in FIG. 1, is a commercial web offset press. The printing press, from its upstream side, is equipped with a paper feed section 1 having a reel stand 11 for supporting a roll 10a of web (continuous paper in the form of a ribbon) 10 as printing paper; an infeed section 2 for sending out web 10 from the paper feed section 1; a printing section 3 with a plurality of printing units (e.g., four printing units) 31 to 34 for performing color printing on paper 10 sent out from the infeed section 2; a dryer section (also referred to simply as a dryer) 4 for drying paper 10 printed in the printing section 3; a cooling section 5 for cooling web 10 dried in the dryer section 4; a web pass section 6 for passing web 10 therethrough while adjusting its phase; and a folding machine 7 for performing cutting-off and folding operations on web 10 passed through the web pass section 6.

The infeed section 2, printing units 31 to 34, cooling section 5, web pass section 6, and folding machine 7 are equipped with drive motors (shaftless motors) 2a, 31a to 34a, 5a, 6a, and 7a so that each of the rotating parts can control to rotate independently of one another. The paper feed section 1 is equipped with a brake 12 for braking web 10 reeled out from the reel stand 11. The drive motors 2a, 31a to 34a, 5a, 6a, and 7a are controlled in rotating speed and phase by a motor controller 8. The motor controller 8 and brake 12 are controlled by a controller (general controller) 9 as control means. Note that the controller 9 is constructed so as to control not only the motor controller 8 (drive motors 2a, 31a to 34a, 5a, 6a, and 7a) and brake 12 but also a variety of control elements of the printing press.

The printing units 31 to 34 are provided with upper plate cylinders 31b to 34b and blanket cylinders 31c to 34c for printing on each face (upper face and lower face) of web 10. (In FIG. 1, reference numerals for the lower plate cylinders 31b to 34b and blanket cylinders 31c to 34c are omitted.) By selecting as a CTP plate, either a normal plate on which drawing by a laser, development, and gumming processes have been performed [CTP plate made by conventional methods (in which film is burned onto a plate)], or a processless (without treatment) plate (processless CTP plate), and placing the selected plate on each of the plate cylinders 31b to 34b, printing can be performed.

The controller 9 is adapted to input plate classification information. When plate exchange is performed from the normal plate to the processless plate, the controller 9 is able to recognize the plate exchange from the plate classification information. For the plate classification information, for instance, a symbol (plate classification symbol) indicative of the processless plate is appended to the file name of higher image information, and by obtaining plate classification information from the file name information, it can be recognized from the plate classification information that plate exchange has been performed from the normal plate to the processless plate. Note that the higher image information is image information employing the original digital data that is to be burned onto a CTP plate. More specifically, the higher image information is obtained by processing the original digital image data (finally 1 bit of data) so that, like CIP3/4 data, resolution is divided into multiple levels.

To recognize that plate exchange has been performed to the processless plate, the printing press may include input means (plate classification selector) for selecting whether the printing plate put on the printing cylinder is the processless plate or not, and an operator may manipulate this input means to input plate classification information to the controller 9.

In printing, an auto preset inking system function (API function) indicating an ink supply quantity (in the case of an ink key system, an ink key opening) as a function of a printing area ratio (image area), a function of setting a peripheral speed ratio between the delivery roller and the ink source roller according to the speed of the printing press (ink speed following function), and a water fountain roller speed following function (function for setting a quantity of rotation of the water source roller according to the speed of the printing press to adjust a water quantity which is supplied to the plate surface of the printing plate and ink rollers), become necessary. These functions are set separately for each of the normal and processless plates.

In the case of the API function, it can be calculated by measuring, for example, image information drawn on a printing plate with an optical image area ratio meter, but even if the same image is measured by the optical image area ratio meter, the measured value varies depending upon the color of plate surface of a printing plate. If the normal plate is compared with the processless plate, they differ in the plate surface composition material of the image forming part of a printing plate and therefore they are generally different in plate surface color. Thus, even if the same image is read with an optical reader, the printing area ratio varies between the normal and processless plates. For that reason, different API functions have to be set separately for the normal and processless plates.

Similarly, for the setting of the ink speed following function and water fountain roller speed following function, different functions need to be set between the normal and process less plates from a difference in the plate surface composition material of the image forming part of a printing plate. That is to say, API function is different, depending on plates' properties, and are similarly different in printing property, so different ink speed following functions and water fountain roller speed following functions must be set separately for the normal and processless plates.

The functions that were set separately for the normal and processless plates have been input and stored in a data storage (not shown) in advance, along with other data related to other operations of the printing press. The controller 9 reads out these operation data (including the function data) from the data storage as needed, and uses them.

Therefore, if plate exchange is performed to the processless plate, the controller 9 recognizes from the input plate classification information that plate exchange has been performed from the normal plate to the processless plate, and reads out operation data (including each function data) corresponding to the processless plate, and uses them to drive the printing press.

When plate exchange is performed to the processless plate, it becomes necessary to perform a development process by a water process before using the processless plate, so the water process is performed by supplying water to the plate surface of the processless plate with a dampener (water supplier) that is employed at the start of printing.

The controller 9, on recognizing that plate exchange has been performed from the normal plate to the processless plate, carries out the water process based on conditions of water process (supply quantity of dampening solution (supply quantity per unit time), plate cylinder speed, web speed, water process time, and so forth) that have been input as preset operation data. That is, the printing cylinders (plate cylinders 31b to 34b and blanket cylinders 31c to 34c) are moved away from web 10 (the plate cylinders are out of contact with the blanket cylinders at this time) In this state, while the printing cylinders (plate cylinders 31b to 34b and blanket cylinders 31c to 34c) are being rotated according to a preset speed schedule by controlling drive motors 31a to 34a, the water feed roller (or dampening roller, not shown) of the dampener is brought into contact with the plate surface of the processless plate (the water feed roller is contacting) to supply water to the plate surface. In this way, the development process is performed.

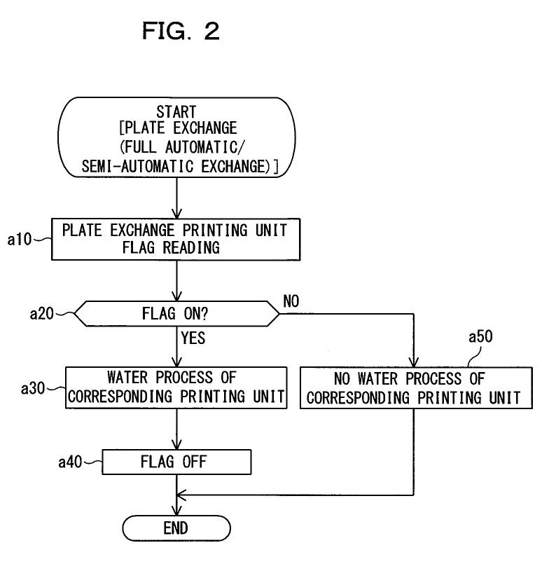

More specifically, in the controller 9, if plate exchange is performed, processing is performed as shown in FIG. 2. The plate exchanger in this case may be fully automatic or semi-automatic. Plate classification information about each of the printing units (called plate exchange printing flag information in this example) is first read (step a10). The plate exchange printing flag is made ON if plate exchange is performed to the processless plate, and OFF if plate exchange is performed to the normal plate. It is then determined whether the plate exchange printing flag is ON or not (step a20). If it is ON, the water process is performed on the corresponding printing unit (step a30). After completion of the water process, the plate exchange printing flag resets to make OFF (step a40). On the other hand, if it is OFF, no water process is performed on the corresponding printing unit (step a50).

The water process is stabilized by increasing a dampening solution quantity to be supplied in the water process more than a normal water quantity to be supplied during printing, and setting it at the maximum value of the water supply quantity per unit time that is supplied by the dampener, or at a predetermined value close to the maximum value. The increase in the dampening solution supply quantity can be implemented by raising the rotation speed of a water source roller (not shown) that supplies dampening solution to the water feed roller. In this embodiment, mode switching is automatically performed in the water process by the controller 9 so that the dampening solution supply quantity can be increased. Of course, the switching may be manually made.

In addition, in the water process, the printing cylinders (plate cylinders 31b to 34b and blanket cylinders 31c to 34c) are operated at high speed to some degree [generally, the regulated speed to the printing speed of the printing press (e.g., 300 rpm to the maximum speed)], while web 10 is moved at slow speed much lower than the printing cylinders [(e.g., a very slow speed or a speed at which paper is threaded into the printing press), or the minimum speed (the minimum printing speed which exceeds the very slow speed)] or is held in a stopped state. The reason the plate cylinders 31b to 34b are rotated at high speed to some degree is, from the view point of water processing, that if they are rotated at high speed to some degree, then a stable development process can be performed on the front surface of the printing plate, and consequently, the development of the entire printing plate can be quickly performed. On the other hand, the reason the speed of paper 10 is reduced is that sincepaper 10 in the water process results in waste paper, the speed of paper 10 needs to be reduced from the viewpoint of minimizing waste paper.

However, if plate cylinders 31b to 34b are rotated excessively at high speed during the water process, transfer (adhesion) of water to the plate surface of the processless plate is reduced, and consequently, there is a possibility of the development process requiring more time. It is preferable to set the rotation speed of the plate cylinders 31b to 34b considering this point. That is, it is preferable to set the rotation speed so that the transfer of water to the plate surface is a predetermined level or greater. Note that for transfer of water, a water transfer quantity to the plate surface per unit time increases as the rotation speed of the plate cylinders 31b to 34b is increased from low speed, but after peaking at a certain rotation speed, the water transfer quantity is reduced as the rotation speed is increased. By grasping such a characteristic experimentally, a range of speeds can be obtained so that transfer of water is a predetermined level or greater. In this manner, the rotation speed can be set so that the transfer of water to the plate surface is a predetermined level or greater.

In addition, if the speed of paper 10 is zero (stopped state), waste paper can be minimized, but if the speed of the paper fiber of paper 10 is reduced excessively or brought into a stopped state, water is concentratedly applied to a certain part of paper 10 during the water process and therefore percolates into paper 10 to greatly reduce the strength of paper 10. As a result, if paper 10 is started, there is a great possibility of paper 10 being cut off. Hence, it is preferable to cause paper 10 to travel at very slow speed to the degree that it is not cut off.

In this case, the cutting-off hardness (i.e., water resistance) of paper 10 when water adheres to paper 10 is varied according to the type of paper 10 that is chosen. For instance, since coated paper 10 is hard to cut off (i.e., high in water resistance) even if water adheres, paper 10 may travel at very low speed. On the other hand, because high-quality paper and bleached paper are easy to cutoff (i.e., low in water resistance) if water adheres, these papers need to travel at higher speed than coated paper to reduce the water quantity that adheres. It is preferable from the viewpoint of waste paper that paper speed be as low as possible. Note that water resistance [(degree of the cutting-off hardness of paper to a water adhesion quantity (in total or per unit time))] also varies according to the basis weight of paper.

Hence, it is preferable to set the speed of paper 10 variable according to the type of paper 10 so that the speed becomes as low as possible (minimum but operable speed) in a range not causing cutting-off of paper 10 according to the water resistance.

The controller 9 causes the plate cylinders 31b to 34b to rotate at the speed of rotation thus set. When the plate cylinders 31b to 34b reach the set rotation speed after they are started, the water feed rollers are brought into contact with the processless plates. When a predetermined total quantity of water is applied to the plate surface of each processless plate, the water feed rollers are moved away from the processless plates, and the plate cylinders 31b to 34b are reduced in speed to a predetermined low speed or reduced in speed until they stop. Note that the total quantity of water is set in advance according to the state (e.g., area to be developed) of a plate surface by an operator etc., and is input to the controller 9.

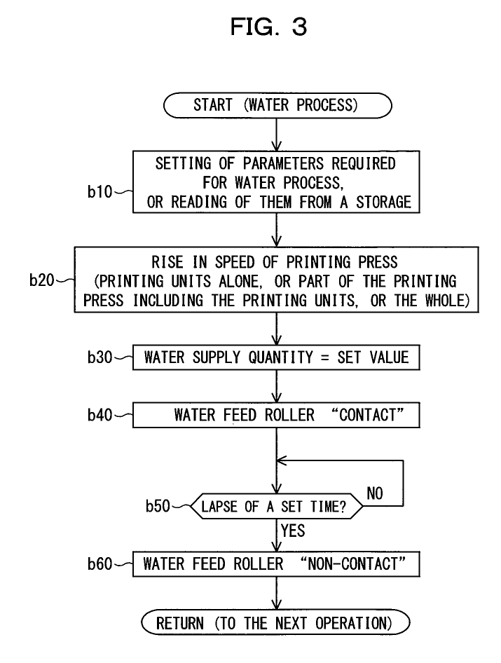

Therefore, the controller 9, as shown in FIG. 3, carries out water processing. That is, parameters required for water processing are set, or read out from the storage device (step b10). The parameters required for water processing are, for example, water-processing speed (speed of the printing units 31 to 34), the amount of time the water feed roller is held in contact with the plate cylinder, and water supply quantity (rotation quantity of the water source roller). Then, by raising the speed of the printing press (only the printing units, or part of the printing press including the printing units, or the whole part) (step b20), the water supply quantity is used as a set value (step b30). That is, the water source roller, for example, after being operated for 30 seconds at the minimum speed, is rotated at the maximum quantity of rotation (maximum speed of rotation). In the case of normal operation (printing), the rotation quantity of the water source roller is proportional to speed based on a certain function etc., but the water source roller speed at the time of water processing is set at a special value higher than the water source roller speed during normal operation. Then, the water feed roller is brought into contact with the plate cylinder (step b40) and held in contact with the plate cylinder until a set time elapses (step b50) so that water is applied. After the set time, the water feed roller is held out of contact with the plate cylinder, whereby the water processing is finished (step b60).

Furthermore, in this embodiment, the temperature of water that is supplied in the water process is adjusted to a preset proper temperature. This embodiment utilizes the water-passing structure of the water source roller to adjust the water temperature.

The water source roller has water-passing structure in the interior thereof so that it can be warmed or cooled by the temperature of water passed therethrough. In printing that originally employs the water-passing structure, since each part of the dampener is overheated by the high-speed operation of each part of the printing press, water is passed through the water source roller to cool the roller, but since water processing is performed in starting the printing press, each part of the dampener is low in temperature during water processing and therefore water itself is low in temperature.

On the other hand, in the case of performing development by water processing, if water to be supplied is raised to high temperature (proper temperature) to some degree, then development can be efficiently performed. Hence, warm water is passed through the water-passing structure of the water source roller to raise the temperature of the water source roller, whereby water is warmed to high temperature (proper temperature) to some degree by the water source roller. Thus, the water-passing structure of the water source roller functions as a means of adjusting the temperature of water to a preset proper temperature. If the temperature of water that is supplied is higher than the proper temperature, it can be reduced to the proper temperature by passing water through the water source roller.

The temperature adjustment means is not limited to the above example, but since this embodiment utilizes the existing water-passing structure, costs are not increased. In addition, since the temperature of water is adjusted immediately before it is supplied, the water temperature can be adjusted with good efficiency and good response, compared with the case where the temperature of water within a water tank is adjusted.

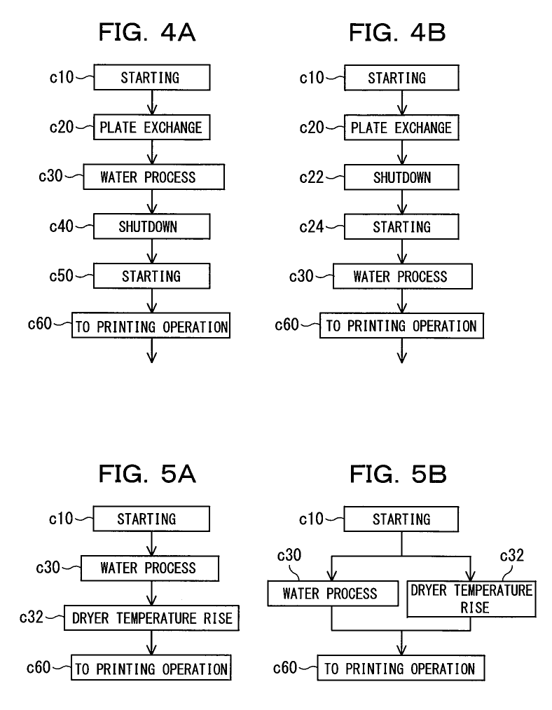

For such water processing, as shown in FIG. 4A, after starting of the printing press (step c10) and completion of plate exchange (step c20), water processing (step c30) may be immediately performed without shutting down the printing press. As shown in FIG. 4B, after starting of the printing press (step c10), then completion of plate exchange (step c20), then shutdown of the printing press (step c22), and restarting of the printing press (step c24), water processing (step c30) may be performed. As shown in FIG. 4A, after water processing (step c30), shutdown of the printing press (step c40), and then restarting of the printing press (step c50), printing operation (step c60) may be started. Furthermore, as shown in FIG. 4B, after water processing (step c30), printing operation (step c60) may be immediately started without shutting down the printing press.

Makereadys for printing, in addition to the above-described water process, as with normal plates, are a dryer temperature raising process, a preliminary ink supply process, and an impression cylinder and/or blanket washing process. These processes other than the water process, as in the case of conventional printing, may be performed after the water process, or may be performed in parallel with the water process.

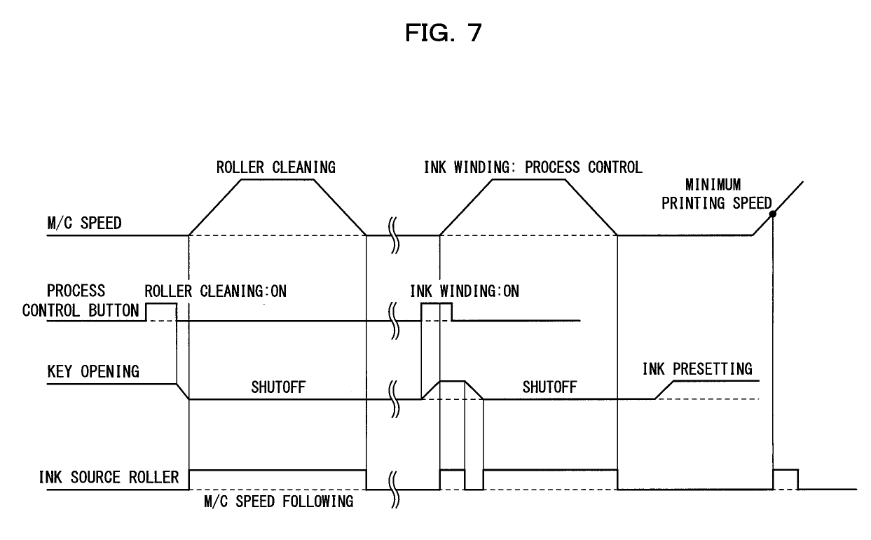

Printing makereadys are shown in FIG. 7 by way of example. The roller washing process is started by manipulation of a process control button for roller cleaning to increase the machine speed to a predetermined speed, and with the key opening made zero (no ink supply), the ink source roller is rotated, as the process control. Thereafter, by manipulation of a process control button for ink winding (preliminary ink supply), an ink winding process is started to increase the machine speed to a predetermined speed, and with the key opening made zero (no ink supply) temporarily at the start of the process, the ink source roller is rotated as needed. In this case, the presetting of the ink key is then performed.

As the water process is performed only on parts that are dampened, it becomes possible to shorten the make ready time by performing the above-described preliminary supply of ink to parts to be inked (function of preliminarily supplying ink to ink rollers and printing density to be stable at a target density quickly) at the same time. In the case of sheet-fed offset printing presses, it is possible to perform the water process in parallel with the impression-cylinder washing process.

For example, directing attention to a dryer temperature raising process, as shown in FIG. 5A, after starting of the printing press (step c10) and completion of the water process (step c30), the dryer temperature raising process (step c32) may be performed, or as shown in FIG. 5B, the dryer temperature raising process (step c32) may be performed in parallel with the water process (step c30) after starting of the printing press (step c10).

The present invention is applicable to both cases shown in FIGS. 5A and 5B, but in this embodiment, as shown in FIG. 5B, the dryer temperature raising process is performed in parallel with the water process.

Particularly, in this embodiment, the timing at which the dryer temperature raising process is started is set according to the start timing of the water process so that the two processes are completed at the same time.

That is, as described above, in the case where web 10 is caused to travel at low speed from the viewpoint of suppressing the occurrence of waste paper, if the water process is not completed even when the dryer temperature raising process is completed, until completion of the water process the web 10 is passed at low speed through the high-temperature dryer 4 in which a rise in temperature has been completed. If web 10 is passed through the high-temperature dryer 4 at low speed, web 10 will be excessively dried by the dryer 4 and the possibility of web 10 being cut off will occur.

If the dryer temperature raising process and water process are completed at the same time, web 10 can be accelerated to the printing speed quickly after completion of the dryer temperature raising process and thus such a possibility can be avoided. From the viewpoint of preventing excessive drying of web 10, even if the dryer temperature raising process and water process are not completed at the same time, it is enough if the water process is completed before completion of the dryer temperature raising process. However, because it is considered that the time required for the water process will become longer than the time required for the dryer temperature raising process, it is preferable from the viewpoint of shortening the make ready time that the two processes be completed at the same time.

Furthermore, in this embodiment, considering substances that are dissolved in water in the water process, or the case where dust etc. produced in the water process are mixed with dampening solution, the controller 9 obtains water process integration information and, on determining from this information that water process history has reached a predetermined level, issues an alarm and indicates the dampening solution exchange. An example of the water process integration information is an integrated value (number of sheets) of the amount of web that travels in the water process. If the number of sheets of web that traveled in the water process reaches a predetermined value (hundreds of sheets), an alarm is issued in order to indicate that the dampening solution exchange is necessary. In the case of having a mechanism for automatically performing the dampening solution exchange, the present invention may be constructed such that the dampening solution exchange is automatically performed.

As the printing-press driving apparatus and method according to this embodiment of the present invention are constructed as described above, the controller 9, at the time of plate exchange, based on plate classification information, determines from a flag signal whether the printing plate is the processless plate or not. If it is the processless plate, the plate cylinders 31b to 34b are rotated at a preset speed without actual contact with web 10, and with a water supplying state (water source roller speed) set at a predetermined value, the water process is performed only for a predetermined period of time with the water feed rollers brought into contact with the plate cylinders.

Therefore, the labor of operators required for water process is greatly lessened, and water process can be performed properly (neither too much nor too little). This makes it possible to minimize the time of water process that is added to the makeready time for printing, whereby an increase in the makeready time resulting from water process and an increase in waste paper associated with this can be suppressed.

Of course, there is no possibility that incomplete water process, a difference in a printing plate of each color, and stains and printing defects at the start of printing, which occur easily when water process for processless plates depends upon the sensibility of an operator, will occur. In addition, there is no possibility that ink will adhere to the printing plates because of forgetting of adjustments to the amount of the dampening solution or insufficient adjustments and thereafter the adhesion will make the printing plates unusable.

The temperature of the dampening solution that is supplied to the printing plates is adjusted to a proper temperature at the time of water process, so it becomes possible to perform water process quickly. Particularly, the existing water-passing structure is used in the water source roller to adjust the temperature of water, so there is no increase in equipment costs. Furthermore, the temperature of water can be efficiently adjusted to a proper temperature, whereby the dampening solution process can be quickly completed.

In the case of the printing plate being the processless plate, if dedicated functions for the processless plate (API function, ink speed following function, and water fountain roller speed following function) are used to control the printing units, printing by the processless plate can be appropriately performed.

In addition, since the water process is carried out in parallel with other processes of the printing makeready (e.g., dryer temperature raising, preliminary ink supply, and impression cylinder or blanket washing processes), the time required for the printing makereadys can be shortened.

In the water process, the printing cylinders (plate cylinders 31b to 34b and blanket cylinders 31c to 34c) are operated at high speed to some extent, while web 10 travels at a speed much lower than the printing cylinders or is caused to be in a stopped state. From the viewpoint of water process, a stable development process can be performed on the front surface of the printing plate if plate cylinders 31b to 34b are operated at high speed to some extent, so that development of the entire printing plate can be quickly performed. On the other hand, web 10 in the water process results in waste paper, so from the viewpoint of suppressing the occurrence of waste paper, as the speed of web 10 is decreased, waste paper can be reduced.

If plate cylinders 31b to 34b are rotated excessively at high speed during water processing, there is a possibility of the development process requiring more time to the contrary, but since the speed of rotation of the plate cylinders 31b to 34b during water process is set taking this point into account, the development process can be efficiently performed in a short time. Without making the speed of web 10 zero (stopped state), if web 10 is caused to travel at very slow speed to the degree that cutting-off of web 10 is not caused, waste paper can be minimized in a range not causing cutting-off of paper.

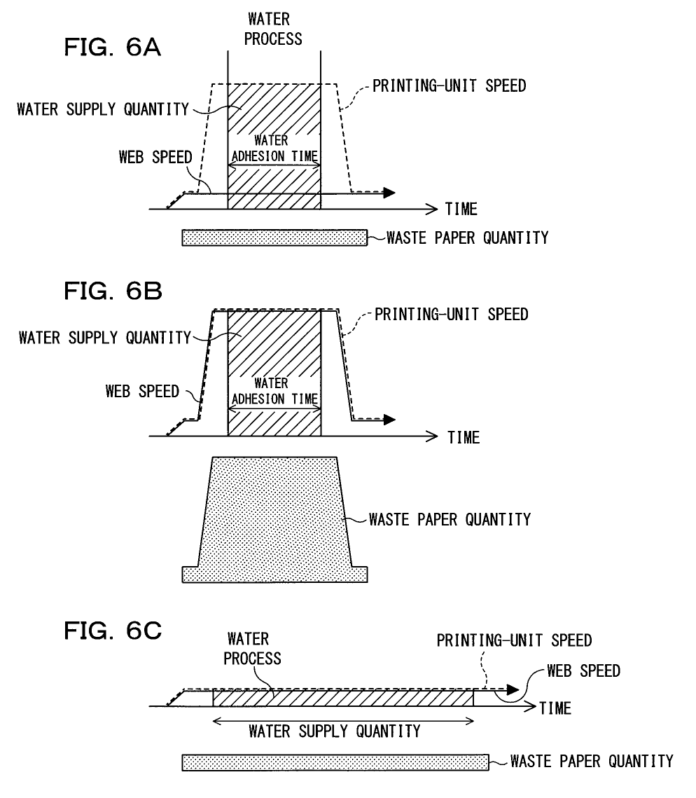

FIGS. 6A to 6C are timing diagrams showing printing-unit speed (speed of plate cylinders 31b to 34b) and web speed. FIG. 6A shows this embodiment, while FIGS. 6B and 6C show comparative examples. Note that a water supply quantity and waste paper quantity are indicated by areas, respectively. As shown in FIGS. 6B and 6C, in the case where printing-unit speed (speed of printing cylinders 31b to 34b) and web speed are made equal to each other, if printing-unit speed is made high so that water processing can be performed with good efficiency as shown in FIG. 6B, high-speed paper travel causes a huge waste paper quantity, and if printing-unit speed is made low as shown in FIG. 6C, water process takes time and thus an increase in paper travel time causes a huge waste paper quantity. By contrast, as shown in FIG. 6A, while printing-unit speed (speed of printing cylinders 31b to 34b) is made high to some degree, and web speed is made much lower than the printing-unit speed in a range not causing cutting-off of web 10, water processing can be performed with better efficiency, and on top of that, a reduction in the travel speed and travel time of web can significantly reduce a waste paper quantity.

In addition, in this embodiment, the timing at which the dryer temperature raising process is started is set according to the start timing of the water process so that the two processes are completed at the same time. Therefore, since web 10 can be accelerated to printing speed soon after the dryer temperature raising process has been completed, the possibility of paper being cut off by excessively drying the continuous paper with the dryer after completion of the dryer temperature raising process can be avoided.

The water process may be completed before completion of the dryer temperature raising process even if the dryer temperature raising process and water process are not completed at the same time, from the viewpoint of preventing excessive drying of web 10, but since it is considered that the time required for the water process will be longer than the time required for the dryer temperature raising process, the makeready time can be shortened as the water process has been completed at the same time when the dryer temperature raising process is completed.

[Others]

While the present invention has been described with reference to the preferred embodiment thereof, the invention is not to be limited to the details given herein.

For example, although it has been described that the above embodiment is equipped with water feed rollers for supplying the dampening solution to the printing plates, it may be equipped with water sprayers for supplying the dampening solution to the printing plates. In this case, water sprayers may be used for spraying the dampening solution in the water process. That is, the present invention may use any type of dampening solution supply device to supply the dampening solution to the printing plates.

In the above embodiment, while each operation in the water process is automatically performed by being controlled by the controller 9, some of the operations may be performed by operator's manipulation (e.g., manipulation of each control button).

In addition, while the above embodiment is applied to a commercial web offset press, the present invention is applicable to other printing presses such as sheet-fed offset printing presses, newspaper web offset rotary presses, etc.

### INDUSTRIAL APPLICABILITY

The present invention is widely applicable in employing processless plates, in a variety of printing presses, such as sheet-fed offset printing presses, commercial web offset presses, and newspaper web presses.

1. An apparatus for driving a printing press capable of printing on continuous paper using a processless plate on which development is performed by a water process in which dampening solution is supplied to a plate surface on a plate cylinder, said apparatus comprising:
control means which, in said water process in the case of employing said processless plate, performs control so that while said plate cylinder with said processless plate placed thereon is being rotated without actual contact with said continuous paper, said water process is performed only for a predetermined period of time, and said continuous paper travels at a lower speed than a peripheral speed of said plate cylinder.

2. The apparatus as set forth in claim 1, wherein said peripheral speed of said plate cylinder in said water process is set at a speed such that transfer of water to a plate surface of said processless plate is a predetermined level or greater.

3. The apparatus as set forth in claim 11, wherein the travel speed of said continuous paper in said water process is set at an operable minimum speed in a speed range in which an adhesion quantity of water to said continuous paper by said water process is within a strength of a water resistance of said continuous paper.

4. The apparatus as set forth in claim 3, wherein the travel speed of said continuous paper in said water process is set variable according to the strength of the water resistance of said continuous paper.

5. The apparatus as set forth in claim 1, wherein said control means performs control so that a rise in temperature of a dryer of said printing press is performed in parallel with said water process, and said water process is completed at the time or before said rise in the dryer temperature is completed.

6. A method of driving a printing press capable of printing on continuous paper using a processless plate on which development is performed by a water process in which a dampening solution is supplied to a plate surface on a plate cylinder, said method comprising:
a control step which, in said water process in the case of employing said processless plate, performs control so that while said plate cylinder with said processless plate placed thereon is being rotated without actual contact with said continuous paper, said water process is performed only for a predetermined period of time, and said continuous paper travels at a lower speed than a peripheral speed of said plate cylinder.

7. The method as set forth in claim 6, wherein said peripheral speed of said plate cylinder in said water process is set at a speed such that transfer of water to a plate surface of said processless plate is a predetermined level or greater.

8. The method as set forth in claim 6, wherein the travel speed of said continuous paper in said water process is set at an operable minimum speed in a speed range in which an adhesion quantity of water to said continuous paper by said water process is within a strength of a water resistance of said continuous paper.

9. The method as set forth in claim 8, wherein the travel speed of said continuous paper in said water process is set variable according to the strength of the water resistance of said continuous paper.

10. The method as set forth in claim 6, wherein, in said control step, control is performed so that a rise in temperature of a dryer of said printing press is performed in parallel with said water process, and said water process is completed at the time or before said rise in the dryer temperature is completed.
